(19) United States
(12) Patent Application Publication
(10) Pub. No.: US 2015/0292467 A1
(43) Pub. Date: Oct. 15, 2015

(54) PLASMA IGNITION DEVICE FOR INTERNAL COMBUSTION ENGINES

(71) Applicant: ELDOR CORPORATION S.P.A., Orsenigo (Como) (IT)

(72) Inventors: Pasquale Forte, Castiglione D'Orcia (Siena) (IT); Luca Franco Bonfanti, Villasanta (Monza Brianza) (IT); Amedeo Colombotto, Cantu' (Como) (IT)

(21) Appl. No.: 14/435,366

(22) PCT Filed: Oct. 17, 2013
(86) PCT No.: PCT/IB2013/059413

§ 371 Date: Apr. 13, 2015

(30) Foreign Application Priority Data
Oct. 19, 2012 (IT) TO2012A000927

(51) Int. Cl. F02P 23/04; F02P 3/04

(52) U.S. Cl. CPC F02P 23/04; F02P 3/0407

(57) ABSTRACT

A plasma ignition device for internal combustion engines is described. It comprises a driving and analog and/or digital control unit, an ignition coil and a spark plug, interconnected each other in a circuit by means of electrical/electronic connection means. The ignition coil comprises two primary windings connected in series each other, having a central electrical connection between the first primary winding and the second primary winding, for electrically charging a capacitor, connected in series to the two primary windings, and for magnetically charging a magnetic core magnetically coupled to a secondary winding of the ignition coil, in order to generate a potential difference across a discharge “gap” of a spark plug.

### BACKGROUND

1. Technical Field

The present disclosure concerns a plasma ignition device for internal combustion engines.

2. Description of the Related Art

There are known internal combustion engines in the prior art that operate by compression of a mixture of air and fuel and the resulting generation of a spark, which, by igniting said mixture, generates a controlled explosion inside one or more combustion chambers within the engine for the purpose of supplying power to said internal combustion engine. The spark is typically generated and supplies high voltage energy to a spark plug exhibiting a specific distance between the electrodes, which is called the “discharge gap”. The resulting discharge triggers combustion of the mixture.

The efficiency and the pollutant emissions characteristic of an internal combustion engine are partly determined by the quality and modes of combustion of the mixture.

In the case in which combustion is not complete, or the spark is not generated and not all of the fuel in the combustion chamber is burned, this amount of unburned mixture will be expelled as exhaust gas from the vehicle equipped with said internal combustion engine. Complete combustion of the total amount of the mixture present in the combustion chamber is also determined by the spark efficiency.

Many possible solutions have been studied with the aim of improving combustion inside an endothermic engine, among which the induction of a plasma state of the gas mixture present in the combustion chamber.

A system the dynamics of which is dominated by electromagnetic forces is called a plasma system: plasma is the set of charged particles and the fields generated by them.

Plasma is the fourth state of matter, obtained by ionization of a gas or a mixture. The state of ionization in which the plasma is found acts in such a manner that it is a good conductor of electricity, and highly responsive to electromagnetic fields.

Therefore, the generation of plasma inside a combustion chamber of an internal combustion engine, precisely because of the characteristics mentioned hereinabove, ensures improvement of the combustion of the mixture. In fact, during its propagation inside the combustion chamber, the flame front generated by the plasma generates very high temperatures in the gaseous mixture, which facilitate rapid propagation of the same flame front, with a reduction of the time needed for its advancement, thereby considerably improving performance and reducing the amount of unburned gases.

In further detail, the generation of a plasma state in a mixture of gases in a combustion chamber of an internal combustion engine comprises the following three stages, which are not separate:

1. breakdown of the dielectric by means of the creation of a spark;

2. high energy ionization of the gas present in the combustion chamber, termed plasma;

3. maintaining the controlled ionization stage or plasma stage.

During the first stage (breakdown of the dielectric by means of the creation of a spark; said stage 1), a potential difference is created across the electrodes of a spark plug, so that a high-energy electrical discharge (stage 1) passes through the dielectric (for example the mixture of air plus fuel). This is followed by the second stage (high-energy ionization of the gas present in the combustion chamber, and termed plasma), during which plasma formation takes place. In this stage (stage 2), combustion of the mixture present in the combustion chamber is triggered. During this stage, there is localized ignition of the mixture of gas and the formation of a flame front. Owing to stage 3 (maintaining the controlled ionization stage or plasma stage), improved propagation of the flame front is ensured by means of an increase in the velocity and intensity of the flame front.

Devices capable of realizing that which is described hereinabove are known in the state of the art.

A known plasma ignition device comprises electrical 9 electronic components necessary for the operation of a high voltage transformer and the electrical connecting means for the power supply. Said electrical/electronic means comprise, among other elements, circuitry for operation of the plasma ignition device. This circuitry is substantially made up of a charging primary circuit, a control circuit for controlling a high voltage transformer, and an ignition circuit, in addition to the electrical connections and the components necessary for the supply of energy.

Specifically, document US2010/0319644 discloses a plasma ignition device composed as follows:

a primary control circuit substantially made up of a current generator, a blocking diode, an inductive element and a capacitor;

a coil driver circuit comprising the above-mentioned capacitor, a diode of an SCR type (silicon-controlled rectifier), a primary winding of a high-voltage transformer (e.g. a high-voltage ignition coil) and a high-voltage blocking element.

The SCR diode provides a switch mechanism that can be activated by an external signal, for the purpose of discharging the capacitor into the primary side of the high-voltage ignition coil. For example, engine control unit (ECU) can activate the SCR diode so as to bring about ignition in a predetermined engine cylinder. The ignition circuit includes a secondary side of the high-voltage transformer and a spark plug or other ignition means. Immediately following the initial application of the discharge pulse (for example, caused by an SCR diode signal), the impedance of the high-voltage transformer increases markedly, as the current passes through the winding of the transformer. The impedance of the high-voltage transformer ensures that the capacitor discharges at a sufficiently slow rate so that a secondary parallel path, protected by the high-voltage blocking element, which connects the output of the capacitor directly to the “gap” between the electrodes of the spark plug, allows the energy remaining in the capacitor to be discharged directly through the initial plasma arc, even though the capacitor is at a lower voltage than the secondary output of the high-voltage transformer. This current thus expands the plasma core, thereby increasing the spark energy, ionizing more gas (air and fuel mixture) and ensuring good combustion. As can be noted from the above, the disclosure that is the object of said document comprises an SCR diode for the part controlling the coil. The diode can be controlled only in the ignition stage, but it cannot be controlled when it is switching off. Therefore, said disclosure does not provide technical means capable of intervening on the timing specific to the described cycle, keeping it constant even with variations in the engine speed, in that the closure of the SCR diode will always take place at the moment when energy in the capacitor is being discharged.

A control unit for generating continuous plasma is disclosed also in the document W02012/106807. Specifically, in said document, an electric potential generating circuit 800 is disclosed (FIG. 8 of the cited document and appearing herein as “FIG. 2”), comprising:

three semiconductor elements: a first diode 803; a second diode 806 and a static switch 807;

three passive components: an inductor 802, a capacitor 804 and a transformer, for example an ignition coil 805.

The electric potential generating circuit 800 further comprises a control unit 809, which is coupled to a gate of the static switch 807 for controlling the switching function of the switch 807. The electric potential generating circuit 800 also includes a DC power supply 801. The negative side of the DC power supply 801 is coupled to ground, while a positive side of the DC power supply 801 is connected to the inductor 802, which is, in turn, coupled to the anode of the first diode 803. The capacitor 804 is coupled to ground on one side, and to the cathode of the first diode 803 on the other side. The cathode of the first diode 803 is also coupled to a first end of a primary winding (I) of the ignition coil 805. A second end of the primary winding (I) of the ignition coil 805 is connected to an anode of the second diode 806, A cathode of the second diode 806 is connected to a connection point of the static switch 807. A gate of the static switch 807 is connected by means of a control line 808 to an output of the control unit 809. A drain of the static switch 807 is connected to the earth. An input line of the control unit 809 is coupled to an input port 811 of the electric potential generating circuit 800. The input port 811 is coupled to a control channel 813. A secondary winding (II) of the ignition coil 805 is coupled to one end of a first terminal 812 of the electric potential generating circuit 800. The first and second terminals 812, 814 of the electric potential generating circuit 800 are coupled externally to respective external electrodes forming a discharge “gap” 816 for use in the presence of a gas mixture (air/fuel) in a combustion chamber.

The electric potential generating circuit 800 may thus be analytically decomposed into four subcircuits. A first subcircuit is a closed circuit comprising the ground, the DC power supply 801, the inductor 802, the first diode 803, the capacitor 804, and the ground. A second subcircuit is a closed circuit comprising the ground, the capacitor 804, the primary winding (I) of the ignition coil 805, the second diode 806, and the static switch 807, and the ground. A third subcircuit is a closed circuit comprising the ground, the DC power supply 801, the inductor 802, the first diode 803, the primary winding (I) of the ignition coil 805, the second diode 806, the static switch 807, and the ground. A fourth subcircuit is a closed circuit comprising the secondary winding (II) of the ignition coil 805, said winding (II) being connected by means of the first and second terminals 812, 814 to a pair of external electrodes forming the discharge “gap” 816.

The operation of the system, circuit and method illustrated in W02012/106807 comprises four stages. During a first stage, the static switch 807 is closed by the control unit 809. The static switch 807 begins charging both the inductor 802 and the ignition coil 805 via the primary winding, to a desired level of current through the third subcircuit. This level of current determines, first, the amount of energy stored within the inductor 802 to be transferred into the capacitor 804, and second, the amount of energy stored into the ignition coil 805.

In the second stage, the static switch 807 is opened by the control unit 809. The static switch 807 ends conducting and the capacitor 804 is charged to a positive voltage through the first subcircuit. At the same time, the energy stored into the ignition coil 805 is released through the fourth subcircuit creating high voltage, say, of negative polarity, in the discharge “gap” 816. If the second stage follows the first initial stage, a dielectric breakdown is actuated in the discharge “gap” 816.

During the third stage, the static switch 807 is closed by the control unit 809. The static switch 807 begins conducting electricity and the capacitor 804 is charged through the second subcircuit, transferring the energy via the ignition coil 805 to the fourth subcircuit, creating high voltage, which is for example of positive polarity, in the discharge “gap” 816.

During the fourth stage, the static switch 807 remains closed, the current through the second subcircuit decreases and the capacitor 804 is recharged to negative voltage, causing an increase of current through the first subcircuit, which charges the inductor 802. By the end of the fourth stage, the gas mixture, which is found in the combustion chamber in the proximity of the discharge “gap” 816, will have been subjected to two initial electric potential pulses. Dielectric breakdown of the gas mixture may occur during the first electric potential pulse, which occurs at the beginning of the second stage, or during the second electric potential pulse, which occurs during the third stage.

The second, third, and fourth stages are repeated so as to generate an oscillating driving potential during the combustion maintenance phase 920, The duration of the ignition delay, prior to the oscillating driving potential, is used to ensure the transition of the gas mixture from the dielectric breakdown through to the ignition thereof.

The oscillating driving potential ensures the flow of electrons through the discharge “gap” so that there is an avalanche-ionization effect,

However, some drawbacks exist in the known state of the art.

One drawback of the known state of the art is the considerable complexity of the control and driving circuits of the considered devices, which require a relatively large number of components for proper functioning, which leads to problems concerning reliability and costs.

Another drawback of the prior art consists in the impossibility of reducing the overall dimensions of the considered device, whereby it cannot in fact be incorporated in other components.

A further drawback consists in the possibility of significant energy loss in the electromagnetic charging stage due to the presence of a number of series inductors at the primary control circuit, which leads to a greater demand for electric energy at the power source.

Fatigue of the electric energy source, along with a resulting reduction in the useful life thereof, is also a drawback of the known state of the art; it is caused by the considerable demand for energy during the stages of electromagnetic charging of the primary winding of the ignition coil.

Furthermore, a drawback of the known state of the at consists in the impossibility of properly controlling the stage of discharging the ionization energy under conditions of high turbulence in the combustion chamber in the presence of high compression ratios or in turbocharged engines. This results in poor performance of said devices under the conditions stated above, with a resulting deterioration of combustion quality, upon variation of the number of revolutions of the engine, and negative impact on engine efficiency and pollutant emissions of the engine.

Lastly, a drawback of the known state of the art consists in the impossibility of housing all the components forming the device on board the ignition coil, thereby requiring added shielding to prevent the emission of electromagnetic interference with increased costs, weight, dimensions, and impact on reliability and performance.

### BRIEF SUMMARY

The present disclosure intends to provide a solution starting from such drawbacks. An aim of the present disclosure is to provide a plasma ignition device for internal combustion engines that allows to reduce the number of components required for its operation, ensuring reliability and flexibility in terms of use.

Another aim of the present disclosure is to provide a plasma ignition device, as specified, which is compact in size.

A further aim of the present disclosure is to disclose a plasma ignition device, as specified, which is capable of minimizing electric energy loss in all stages of operation and particularly in the stage for electromagnetic charging of the primary winding of the ignition coil.

A consequent aim of the present disclosure is to provide a device, as specified, which is capable of minimizing, to the greatest feasible extent, the electric energy requirements thereof.

A further aim of the present disclosure is to provide a device, as stated hereinabove, which is capable of reducing fatigue of the electric energy source with a resulting increase in the useful life of said component.

Yet another aim of the present disclosure is to supply a plasma ignition device, as specified, which is capable of operating even in the presence of high pressure and turbulence levels, improving combustion at all rotation speeds and with rotation speed variation of the internal combustion engine, improving performance (increasing efficiency by reducing consumption levels and improving the heat exchange process), and minimizing the pollutant emissions of said engine.

The possibility of supplying a plasma ignition device, as specified, which is capable of being entirely assembled on board ignition coils of limited dimensions and not requiring additional electromagnetic emission filters and shields is also an aim of the object of this disclosure.

Lastly, an aim of the present disclosure is to provide a plasma ignition device, as specified, which is easy to implement, convenient to use, and offering limited costs, improved performance, reduced dimensions and high reliability.

In view of these aims, the present disclosure provides a plasma ignition device for internal combustion engines, the essential characteristic of which is the object of claims 1 and 8.

Further advantageous characteristics are listed in the dependent claims.

All the claims are intended as integrally reported herein.

### BRIEF DESCRIPTION OF THE SEVERAL VIEWS OF THE DRAWINGS

The present disclosure will be described more fully below with reference to the attached drawings, provided solely by way of illustrative, non-limiting example, in which:

FIG. 1 is a schematic and illustrative representation of a plasma ignition device for internal combustion engines according to the present disclosure,

FIG. 2 shows a circuit as known in the state of the art.

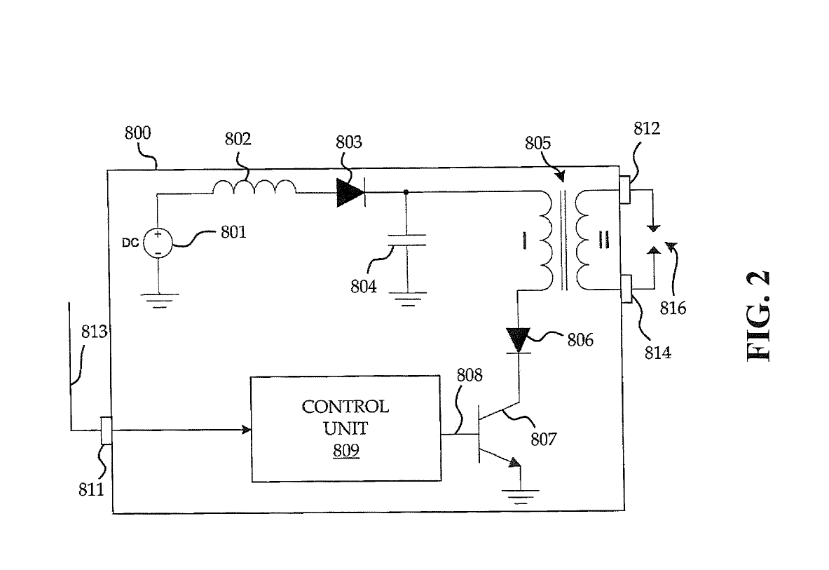

### DETAILED DESCRIPTION

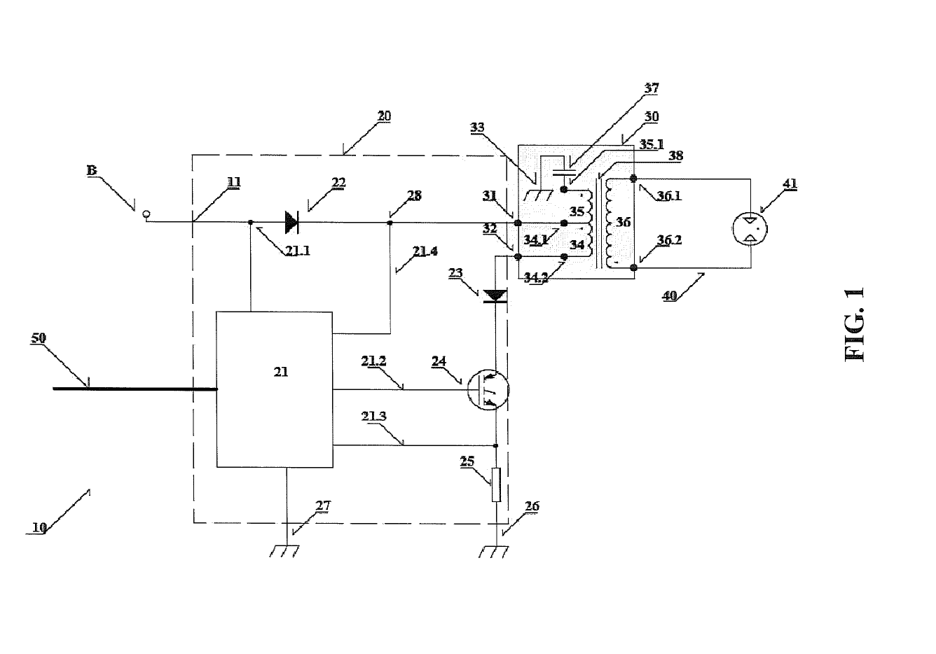

In FIG. 1, the plasma ignition device for internal combustion engines, the object of the present disclosure, is indicated in its entirety by the number 10. It principally comprises:

a driving and analog and/or digital control unit 20;

an ignition coil 30;

a spark plug 40;

a voltage generator, for example a battery B;

connections 50 from and for an engine control unit, ECU (in and of itself known in the art and not illustrated herein).

Said driving and analog and/or digital control unit 20 substantially comprises:

a driving and control unit 21;

a first diode 22;

a second diode 23;

a static switch 24;

a resistor 25;

a voltage control device 28.

Said ignition coil 30 substantially comprises:

a first primary winding 34;

a second primary winding 35;

a secondary winding 36;

a capacitor 37;

an electromagnetic core 38.

Said spark plug 40 comprises:

a discharge “gap” 41.

### Main Electrical Connections

With reference to FIG. 1, the driving and analog and/or digital control unit 20 is connected electrically: on one side, to an engine control unit ECU (in and of itself known in the art and not illustrated herein) and to a voltage generator B, by means of a bidirectional, analog and/or digital bus-type connection 50 and by means of a suitable electrical connection 11, respectively, and, on the other side, to an ignition coil 30 and to the ground by means of electrical connections 31 and 32, and ground connections 26 and 27, respectively.

In addition to the two above-mentioned connections 31 and 32 to the driving and analog and/or digital control unit 20, the ignition coil 30 has a ground connection 33 and two connections 36.1 and 36.2 for electrical communication between said ignition coil 30 and the spark plug 40.

Internally, the driving and analog and/or digital control unit 20 has a driving and control unit 21 to which the following internal components are electrically connected: the first diode 22 by means of connecting elements 21.1 and 21.4; the static switch 24 by means of a connecting element 21.2 and the resistor 25 by means of a connecting element 21.3.

Internally, the ignition coil 30 has two primary windings 34 and 35, connected in series each other. Moreover, the set of the two said primary windings 34 and 35 are connected in series to the capacitor 37 by means of a connection 35.1. Said capacitor 37 is, in turn, connected in series to the ground by means of a connection 33. Said two primary windings 34 and 35 are connected, as stated above, on one side to the capacitor 37 by means of the connection 35.1 and on the other side to the connection 32 for electrical communication between said driving and analog and/or digital control unit 20 and the ignition coil 30. Moreover, said two primary windings 34 and 35 are connected to the connection 31 by means of the central connection 34.1 located between said two windings.

By means of the magnetic core 38, the secondary winding 36 is set in magnetic communication with the two primary windings 34 and 35.

### Operation

The operation of the plasma ignition device for internal combustion engines, the object of the present disclosure, substantially comprises five stages.

During the first stage, the static switch 24 is closed by the driving and control unit 21. The static switch 24 begins to charge the ignition coil 30 by means of the first primary winding 34, until a given current level is reached (measured in amperes by the resistor 25) through a circuit composed of a voltage generator B, for example a battery, through the connection 11, the first diode 22, the first primary winding 34 through the connection 31 and the connection 34.1, the second diode 23 through the connection 34.2 and the connection 32, the static switch 24 and the resistor 25 towards the ground connection 26. At the same time, the flow of the electromotive force induced by the first primary winding 34 connected in series to the second primary winding 35, generates a reverse current which, through the second primary winding 35 and respective connection 35.1, charges the capacitor 37 to a positive voltage.

Control of the value of the current flowing in said circuit takes place, as stated, by means of the resistor 25, across which the driving and control unit 21 detects an electric potential difference proportional to the flow current value. The driving and control unit 21 monitors the resistor 25 until a predetermined electric potential difference is reached across it. Reaching said predetermined value across said resistor 25 ensures a maximization of energy stored into the ignition coil 30.

The static switch 24 is then driven to open by the driving and control unit 21 through the connection 21.2. The static switch 24 thus interrupts electrical contact, thereby blocking the described flow of current. Precisely because of said interruption on the primary windings 34 and 35, overvoltage is generated, which opposes the change in current. A reverse flow of current is thus generated, which sets the capacitor 37 in a positive-voltage charging state. The capacitor 37 charge is based on the number of turns in the second primary winding 35 as opposed to the first primary winding 34.

In the second stage, the static switch 24 is still open and the energy stored into the ignition coil 30, more precisely in the magnetic core 38, is released through the secondary winding 36 and the connections 36.1 and 36,2, thereby generating high voltage, for example of negative polarity, in the discharge “gar” of the spark plug 40.

During the third stage, the static switch 24 is closed by the driving and control unit 21 by means of the connection 21.2. The static switch 24 allows the electric energy to flow through the circuit composed of the voltage generator B and the respective connection 11, of the first diode 22, of the voltage control device 28, of the connection 31 and of the connection 34.1, of the first primary winding 34 and the respective connection 34.2, of the connection 32, of the second diode 23, of the static switch 24, of the resistor 25 and of the ground connection 26. In this manner, a current is generated that flows through the first primary winding 34 discharging the capacitor 37, through the second primary winding 35 transferring inductive energy in addition to capacitive energy, through the magnetic core 38, to the second secondary winding 36 which, by means of the connections 36.1 and 36.2 generates an high voltage which is for example of positive polarity, in the discharge “gap” 41 of the spark plug 40.

During the fourth stage, the static switch 24 remains closed, the value of the current passing through the circuit described hereinabove decreases and the capacitor 37 discharges through the second primary winding 35, causing an increase of current through the first primary winding 34 which recharges the ignition coil 30.

During said operation, the mixture of air and fuel is subjected to two electric pulses: one of negative potential and one of positive potential. The dielectric breakdown generally takes place during the first pulse, for example a negative pulse, generated during the second stage of operation, or during the second pulse, for example a positive pulse, occurring during the third stage of operation.

During the fifth stage of operation the driving and control unit 21 drives, by means of hardware and software means, the static switch 24 with a PWM (pulse width modulation) command at a predetermined frequency, controlling the closing Ton and opening Toff times of the static switch 24. Said opening Toff and closing Ton times are determined by the driving and control unit 21 by means of an algorithm that processes the data supplied by the analysis of the predetermined parameters and obtained by monitoring a feedback loop composed of the voltage control device 28 and the respective connection 21.4 for connection to the driving and control unit 21, of the connection 31, of the connection 34.1 and of the connection 32, of the second diode 23, of the static switch 24, of the resistor 25 and of the ground connection 26. Owing to the zero-current-switching PWM technique, the driving and control unit 21 can vary, by means of hardware and software means, the opening and closing times of the static switch 24, as well as the switching period.

This switching generates a high-voltage electric potential on the secondary winding 36, oscillating between a positive value and a negative value and capable of maintaining the gas/mixture across the discharge “gap” 41 under plasma conditions for the period of time established by the engine control unit ECU (in and of itself known in the art and not illustrated herein). Said oscillating electric potential maintains an electric arc across the discharge “gap” 41 of the spark plug 40, thereby allowing the flow of the current in the secondary winding 36, facilitating expansion of the gas/mixture in a plasma state with the resulting formation of a flame front, by means of which combustion of the mixture of gases present in the combustion chamber is triggered. The effect described above is known as the avalanche-ionization effect.

### Advantages

The present disclosure advantageously allows to achieve all the aims listed hereinabove.

Specifically, the person skilled in the art will note that the reduction of external components, with a resulting increase in the efficiency of the circuit in terms of electric/magnetic yield, ensures the implementation of a plasma ignition device that occupies less space and offers greater reliability and a high level of flexibility in terms of use, with adaptation to utilization in various internal combustion engines, each of which having its own special needs as regards combustion control.

Moreover, it can be noted that during the first stage of operation, only the first primary winding 34 is responsible for charging the coil 30. In this manner, there is a lower demand for energy from the voltage generator B, with respect to that teached by the prior art. This characteristic advantageously increases the useful life of said voltage generator B, ensuring lower operating costs and improved reliability.

Thanks to the device which is the object of the present disclosure, it is possible to obtain a greater accumulation of energy inside the coil 30, thereby generating a spark that is more powerful and ensuring better combustion inside the combustion chamber of the engine, resulting in better performance and reduced emission of pollutants.

A further advantage of the present disclosure is provided by the possibility of operating in situations with the gas mixture having high turbulence and pressure levels. This makes it possible to equip internal combustion engines with the present device, thus achieving improved performance levels compared to the levels available as yet in the state of the art.

Moreover, the present disclosure is not affected by possible voltage spikes generated by the voltage generator 13 and it is capable of eliminating any undesirable effects of said voltage spikes, owing to the advantageous architecture of the circuit.

In one embodiment, the present disclosure allows to reduce charge loss across the static switch 24, owing to the employment of a control by means of zero-current switching.

A further advantage of the present disclosure is the presence of the feedback loop, which allows mapping of the various stages of operation and of the avalanche effect.

Lastly, in one embodiment the present disclosure allows to reduce the dimensions of the electric/magnetic circuits installed on board the ignition coil by over 50%, resulting in a decrease in weight, electrical losses and the cost of the component. Furthermore, as the electric/magnetic components are installed on board the coil, it is not necessary to provide further electromagnetic shields or filters.

1. A plasma ignition device for internal combustion engines comprising a driving and analog and/or digital control unit, an ignition coil, a spark plug, interconnected each other in a circuit by means of electrical/electronic connection means wherein said ignition coil comprises two primary windings connected in series each other, having a central electrical connection between the first primary winding and the second primary winding, for electrically charging a capacitor, connected in series to the two said primary windings, and for magnetically charging a magnetic core magnetically coupled to a secondary winding of said ignition coil in order to generate a potential difference across a discharge “gap” of a spark plug.

2. The plasma ignition device according to claim 1, wherein said driving and analog and/or digital control unit comprises a driving and control unit, a first diode, a second diode, a static switch, a resistor, a voltage control device, so as to perform, by driving the static switch, the opening/closing of the electric/magnetic circuit responsible for electrically/magnetically charging/discharging said two primary windings, of said secondary winding and of the magnetic core.

3. The plasma ignition device according to claim 2, wherein said driving and analog and/or digital control unit comprises said driving and control unit and at least one electrical I electronic connection for receiving the pulses/commands from an external engine control unit, in case said pulses/commands are not generated by said driving and control unit.

4. The plasma ignition device according to claim 2, wherein said driving and analog and/or digital control unit comprises an electrical connection between said voltage control device and said central electrical connectino and a second electrical connection between said first primary winding and said diode.

5. The plasma ignition device according to claim 2, compressing a feedback loop circuit composed of said voltage control device, of said first primary winding, of said second diode, of said static switch and of said resistor this latter element being connected to ground by means of a connection, so that said driving and control unit determines the opening/closing times of said static switch by means of said feedback loop circuit.

6. The plasma ignition device according to claim 2, wherein said driving and control unit comprises hardware and software means for driving said static switch by means of pulse width modulation.

7. The plasma ignition device according to claim 2, wherein said driving and control unit comprises hardware and software means for driving, by means of zero-current switching, said static switch varying the opening/closing times and/or period thereof so that said zero-current switching generates, in the secondary winding, an oscillating electric potential and so that said oscillating electric potential generates and maintains active at least one electric are across a discharge “gap” of a spark plug.

8. A plasma ignition device for internal combustion engines comprising:
a driving and control unit;
an ignition coil;
said ignition coil comprising:
a first primary winding and a second primary winding having a central electrical connection between the first primary winding and the second primary winding;
a secondary winding magnetically coupled to the first and second primary winding and connected to a spark plug;
a capacitor connected between the second primary winding and a ground connection;
wherein the driving and control unit comprises:
a first diode interposed between a voltage generator and the central electrical connection;
a second diode having the anode terminal connected to the first primary winding;
a switch having a connection to the catode terminal of the second diode;
wherein the driving and control unit is configured to drive the opening and closing of the switch in order to charge and discharge the first primary winding and to charge and discharge the capacitor for generating a spark between the electrodes of the spark plug.

9. The plasma ignition device according to claim 8, farther comprising a resistor interposed between the switch and the ground connection, wherein the driving and control unit is connected to the resistor and is further configured to detect the electric potential difference proportional to the value of the current flowing into the resistor.

10. The plasma ignition device according to claim 8, wherein the driving and control unit is further configured to:
during a first stage, driving the closing of the switch in order to charge the first primary winding and the capacitor and afterwards driving the opening of the switch when the driving and control unit detects that the electric potential difference across the resistor has reached a predetermined value;
during a second stage, maintain the switch open in order to transfer energy from the first primary winding to the secondary winding.

11. The plasma ignition device according to claim 10, wherein the driving and control unit is further configured to:
during a third stage, close the switch in order to discharge the capacitor through the second primary winding and transfer energy to the secondary winding;
during a fourth stage, maintain the switch closed in order to discharge the capacitor through the second primary winding.

12. The plasma ignition device according to claim 11, wherein the driving and control unit is further configured, during a fifth stage, to drive the opening and closing of the switch by means of pulse width, modulation at a predetermined frequency.

13. The plasma ignition device according to claim 12, wherein the driving and control unit comprises a feedback loop composed of the driving and control unit, the first primary coil, the second diode, the switch and the resistor.
